(19) United States
(12) Patent Application Publication
(10) Pub. No.: US 2025/0078791 A1
(43) Pub. Date: Mar. 6, 2025

(54) ELECTRONIC MUSICAL INSTRUMENT, METHOD, AND NON-TRANSITORY RECORDING MEDIUM

(71) Applicant: CASIO COMPUTER CO., LTD., Tokyo (JP)

(72) Inventors: Tomoya KAJIKAWA, Tokyo (JP); Shingo OKANO, Tokyo (JP); Osamu MORIYAMA, Tokyo (JP); Ken TERAO, Tokyo (JP); Tatsuro TSUCHIYA, Tokyo (JP); Yuki KURIHARA, Tokyo (JP)

(21) Appl. No.: 18/814,995

(22) Filed: Aug. 26, 2024

(30) Foreign Application Priority Data
Aug. 29, 2023 (JP) 2023-139112

(51) Int. Cl. G10H 1/00

(52) U.S. Cl. CPC G10H 1/0033

(57) ABSTRACT

An electronic musical instrument includes a performance operating element, a storage unit configured to store performance data corresponding to an operation each time a user operates the performance operating element, and at least one processor. The at least one processor executes, in a first period, processing of storing the performance data in the storage unit in response to the operation of the user on the performance operating element in a case of being in a recording state. The at least one processor executes, in a second period longer than the first period, processing of outputting the performance data stored in the storage unit in a case of being in a reproduction state.

### CROSS-REFERENCE TO RELATED APPLICATIONS

This application is based on and claims priority under 35 USC 119 from Japanese Patent Application No. 2023-139112 filed on Aug. 29, 2023, the entire content of which is incorporated herein by reference.

### TECHNICAL FIELD

The present disclosure relates to an electronic musical instrument, a method, and a non-transitory recording medium.

### BACKGROUND ART

Electronic musical instruments capable of recording and reproducing a performance performed by a user are known. For example, an electronic musical instrument described in JP2008-152054A reproduces a performance which has been recorded in response to a user operation.

### SUMMARY

An electronic musical instrument includes a performance operating element, a storage unit configured to store performance data corresponding to an operation each time a user operates the performance operating element, and at least one processor. The at least one processor executes, in a first period, processing of storing the performance data in the storage unit in response to the operation of the user on the performance operating element in a case of being in a recording state, and in a second period longer than the first period, processing of outputting the performance data stored in the storage unit in a case of being in a reproduction state.

According to the present disclosure, it is possible to provide an electronic musical instrument, a method, and a program capable of preventing a failure in which reproduced sound is not appropriately reproduced.

### BRIEF DESCRIPTION OF DRAWINGS

FIG. 1 is a diagram illustrating an external appearance of an electronic musical instrument according to an embodiment of the present disclosure;

FIG. 2 is a block diagram illustrating a configuration of the electronic musical instrument according to the embodiment of the present disclosure;

FIG. 3 is an explanatory diagram relating to writing of performance data to a ring buffer provided in the electronic musical instrument according to the embodiment of the present disclosure;

FIG. 4 is a state transition diagram of a processor provided in the electronic musical instrument according to the embodiment of the present disclosure;

FIG. 5A is an explanatory diagram relating to the writing of the performance data to the ring buffer in the embodiment of the present disclosure;

FIG. 5B is an explanatory diagram relating to the writing of the performance data to the ring buffer in the embodiment of the present disclosure;

FIG. 6 is an explanatory diagram relating to a reproduction start point in response to a key pressing operation on a white key of the electronic musical instrument according to the embodiment of the present disclosure;

FIG. 7 is a diagram illustrating an example of fast rewind processing in response to the key pressing operation on the white key of the electronic musical instrument according to the embodiment of the present disclosure;

FIG. 8 is an explanatory diagram relating to a reproduction start point in response to a key pressing operation on a black key of the electronic musical instrument according to the embodiment of the present disclosure;

FIG. 9 is a diagram illustrating an example of a processing timing when the performance data is reproduced in the embodiment of the present disclosure;

FIG. 10 is a flowchart of recording processing executed by the processor in the embodiment of the present disclosure;

FIG. 11 is a subroutine of a recording task (step S102) shown in FIG. 10;

FIG. 12 is a flowchart of reproduction processing executed by the processor in the embodiment of the present disclosure;

FIG. 13 is a subroutine of reproduction start point determination processing (step S301) shown in FIG. 12; and

FIG. 14 is a subroutine of an output task (step S305) shown in FIG. 12.

### DESCRIPTION OF EMBODIMENTS

In the electronic musical instrument described in JP2008-152054A, as a sampling rate at the time of reproduction processing is increased, the recorded performance can be reproduced with high reproducibility. On the other hand, as the sampling rate is increased, a processing load of the electronic musical instrument increases. Due to an influence of the increase in processing load, a reproduced sound may not be appropriately reproduced (for example, the reproduced sound slows down). In contrast, according to the present disclosure, it is possible to prevent a failure in which the reproduced sound is not appropriately reproduced.

An electronic musical instrument, and a method and a program executed by the electronic musical instrument, which is an example of a computer, according to an embodiment of the present invention will be described in detail with reference to the drawings.

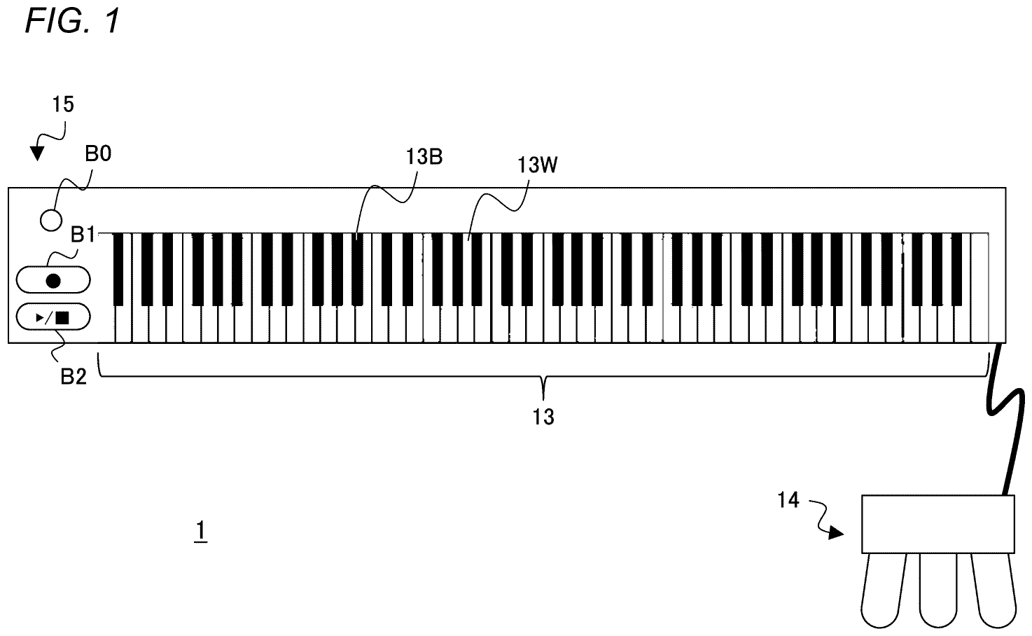

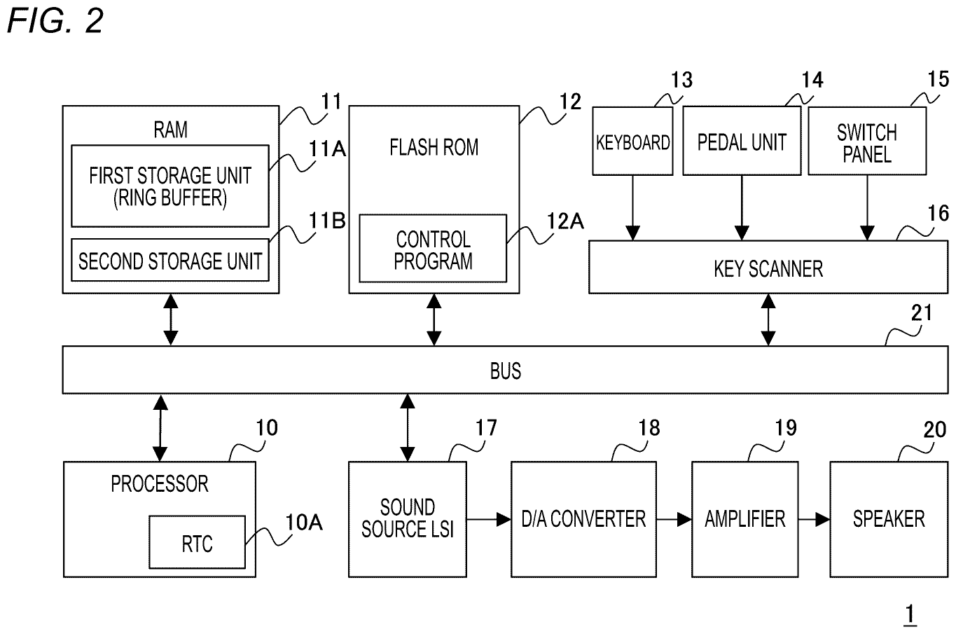

FIG. 1 is a diagram illustrating an external appearance of an electronic musical instrument 1 according to the embodiment of the present invention. FIG. 2 is a block diagram illustrating a configuration of the electronic musical instrument 1. The electronic musical instrument 1 is, for example, an electronic keyboard. The electronic musical instrument 1 may be an electronic keyboard instrument other than an electronic keyboard, such as an electronic piano. The electronic musical instrument 1 may be an electronic musical instrument of another form such as an electronic percussion instrument, an electronic wind instrument, or an electronic stringed instrument.

The electronic musical instrument 1 has a hardware configuration including a processor 10, a random access memory (RAM) 11, a flash read only memory (ROM) 12, a keyboard 13, a pedal unit 14, a switch panel 15, a key scanner 16, a sound source large scale integration (LSI) 17, a D/A converter 18, an amplifier 19, and a speaker 20. The units of the electronic musical instrument 1 are connected to a bus 21.

The processor 10 reads a program and data stored in the flash ROM 12. The processor 10 collectively controls the electronic musical instrument 1 by using the RAM 11 as a work area.

The processor 10 is, for example, a single processor or multiple processors, and includes at least one processor. In a case of a configuration including multiple processors, the processor 10 may be packaged as a single device, or may include a plurality of devices physically separated inside the electronic musical instrument 1. The processor 10 may be referred to as a controller, a central processing unit (CPU), a micro processor unit (MPU), or a micro controller unit (MCU), for example.

The processor 10 includes a real time clock (RTC) 10A. The RTC 10A generates and outputs digital data (an example of a system time) of a date and a time point.

The RAM 11 temporarily stores data and a program. The RAM 11 stores various data such as various programs and waveform data read from the flash ROM 12.

As illustrated in FIG. 2, a first storage unit 11A and a second storage unit 11B are ensured in the RAM 11. The second storage unit 11B is an example of a storage unit different from the first storage unit 11A. A storage unit that ensures the first storage unit 11A and a storage unit that ensures the second storage unit 11B may be separate.

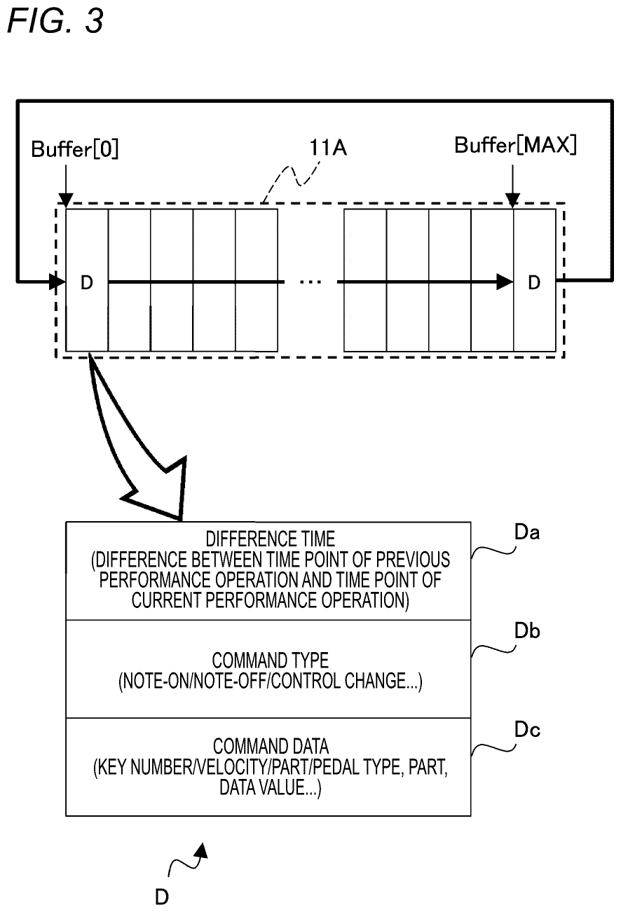

FIG. 3 is an explanatory diagram relating to writing of performance data D to the first storage unit 11A. The first storage unit 11A is an example of a ring buffer, and operates as a first in first out (FIFO) buffer in which a front end (buffer [0]) and a terminal end (buffer [MAX]) are logically connected.

As shown in FIG. 3, the processor 10 sequentially writes the performance data D from the front end (buffer [0]) to the terminal end (buffer [MAX]) of the first storage unit 11A. The performance data D is data generated by the processor 10 for each performance operation performed on one performance operating element.

That is, the first storage unit 11A is an example of a storage unit that stores the performance data D corresponding to an operation each time a user operates any one of a plurality of performance operating elements. In addition, the first storage unit 11A is an example of a ring buffer that stores first performance data D corresponding to an operation on a key each time the user operates the key, which is an example of the performance operating element, and stores second performance data D corresponding to an operation on a pedal each time the user operates the pedal, which is an example of a second operating element.

The first storage unit 11A is an example of a first storage area (ring buffer area) that stores the performance data D (an example of first performance data) corresponding to the operation on the performance operating element and performance data (an example of second performance data, which is later-described performance data P, setting change information of tones and various effects) corresponding to the operation on the second operating element.

After writing the performance data D to the terminal end (buffer [MAX]) of the first storage unit 11A, the processor 10 moves a recording pointer (latest recording point PT2 to be described later) to the front end (buffer [0]) of the first storage unit 11A. After moving the recording pointer, the processor 10 again writes the performance data D in sequence from the front end (Buffer [0]).

The performance data D includes various information such as a difference time Da, a command type Db, and command data Dc.

The difference time Da is an example of difference time information. The difference time Da is a time difference between a time (time point) at which the user operated any one of the performance operating elements last time and a time (time point) at which the user currently operates any one of the performance operating elements. For example, when the user operates one key on the keyboard 13 and then operates one key, a time difference between these two performance operations is the difference time Da. The processor 10 acquires the time point (an example of the system time) when the performance operation is performed from the RTC 10A.

The command type Db includes note-on, note-off, control change, and the like.

The command data Dc includes a key number, a velocity, a part, a pedal type, a data value, and the like.

When the recording pointer moves to the front end (Buffer [0]) of the first storage unit 11A and new performance data D is written, the performance data D stored in a writing area is overwritten with the new performance data D. As will be described in detail later, the second storage unit 11B stores the performance data D of the pedal which is erased by performing overwriting in the first storage unit 11A. That is, the second storage unit 11B is an example of a second storage area that stores the second performance data.

The performance data D in the first storage unit 11A and the second storage unit 11B disappear when a power supply of the electronic musical instrument 1 is turned off.

The flash ROM 12 is a nonvolatile semiconductor memory such as a flash memory, an erasable programmable ROM (EPROM), or an electrically erasable programmable ROM (EEPROM). As an example, the flash ROM 12 stores a control program 12A that executes various types of processing according to the embodiment of the present invention.

The keyboard 13 includes 88 keys as the performance operating elements. Specifically, the keyboard 13 includes 52 white keys 13W and 36 black keys 13B. The respective keys are associated with different pitches. The electronic musical instrument 1 generates a musical sound in response to a key pressing operation on the key of the keyboard 13.

The number of keys of the keyboard 13 is not limited to 88. The keyboard 13 may include other numbers of keys such as 61 keys and 76 keys.

The pedal unit 14 includes three pedals as the performance operating elements. Specifically, the pedal unit 14 includes a damper pedal, a soft pedal, and a sostenuto pedal. When the user performs the key pressing operation on the key while stepping on the pedal, the electronic musical instrument 1 adds an acoustic effect corresponding to the pedal which is being stepped on to the musical sound and performs sound generation processing.

That is, the pedal unit 14 is an example of the second operating element that adds an effect (for example, an acoustic effect) to the musical sound corresponding to the key that is an example of the performance operating element.

The switch panel 15 includes a power supply button B0, a recording button B1, and a reproduction/stop button B2. Although not shown for convenience, the switch panel 15 also includes other operating elements for adjusting parameters such as sound volume and a tone and selecting an item.

The user can turn on or off a power supply of the electronic musical instrument 1 by pressing the power supply button B0. The user can record a performance performed using the electronic musical instrument 1 by pressing the recording button B1. The user can reproduce and stop the performance data D stored in the electronic musical instrument 1 by pressing the reproduction/stop button B2.

For convenience, the power supply button B0, the recording button B1, and the reproduction/stop button B2 may be abbreviated as buttons B0, B1, and B2, respectively.

The switch panel 15 may include operating elements other than the buttons B0 to B2.

The key scanner 16 monitors key pressing and key releasing on the keyboard 13. When the key pressing operation performed by the user is detected, for example, the key scanner 16 outputs a key pressing event to the processor 10. The key pressing event includes information on the pitch of the key (key number) related to the key pressing operation. The key number may be referred to as a key number, a musical instrument digital interface (MIDI) key, or a note number.

In the present embodiment, a unit that measures a key pressing speed of the key (velocity) is provided separately. The velocity measured by this unit is also included in the key pressing event. For example, the respective keys are provided with a plurality of contact switches. The velocity is measured by a difference in time during which each contact switch is conducted in response to the keys being pressed. The velocity may be a value indicating the strength of the key pressing operation or a value indicating the magnitude (sound volume) of the musical sound.

Waveform data is stored in the flash ROM 12 or another memory (not shown). The waveform data is loaded into the RAM 11 at the time of activating the electronic musical instrument 1 so that the musical sound is quickly generated in response to the key pressing operation. When the key pressing operation is detected by the key scanner 16, the processor 10 instructs the sound source LSI 17 to read the corresponding waveform data from the waveform data loaded in the RAM 11. The waveform data to be read is determined, for example, in accordance with the tone and the key pressing event selected by the operation of the user.

The sound source LSI 17 generates the musical sound based on the waveform data read from the RAM 11 under the instruction of the processor 10. The sound source LSI 17 includes, for example, 128 generator sections, and can simultaneously generate 128 musical sounds at the maximum. In the present embodiment, the processor 10 and the sound source LSI 17 are formed as separate processors, and in another embodiment, the processor 10 and the sound source LSI 17 may be formed as one processor.

Digital musical sound data generated by the sound source LSI 17 is converted into an analog signal by a D/A converter 18, amplified by the amplifier 19, and output to the speaker 20.

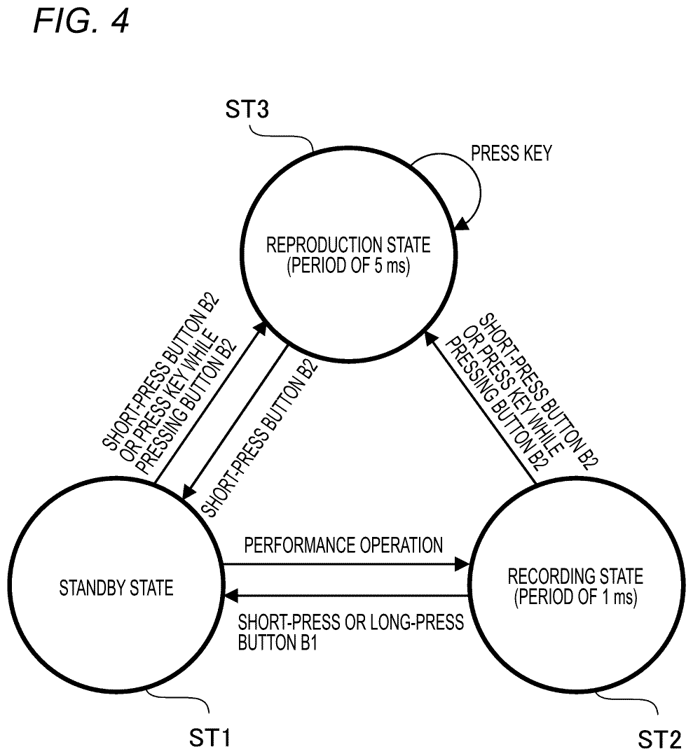

FIG. 4 is a state transition diagram of the processor 10. As illustrated in FIG. 4, the processor 10 moves among three states, that is, a standby state ST1, a recording state ST2, and a reproduction state ST3. The standby state ST1 is a state in which the electronic musical instrument 1 waits for the record and the reproduction of the performance performed by the user. The recording state ST2 is a state in which the electronic musical instrument 1 records the performance performed by the user. The reproduction state ST3 is a state in which the recorded performance is reproduced (replayed).

When the user presses the power supply button B0 while the power supply of the electronic musical instrument 1 is turned off, the electronic musical instrument 1 is activated. Accordingly, the processor 10 enters the standby state ST1.

When the user performs the performance operation in the standby state ST1, the processor 10 transitions to the recording state ST2. This performance operation is the key pressing operation on any one of the keys of the keyboard 13, or a stepping-on operation on any one of the pedals of the pedal unit 14. That is, the processor 10 transitions from the standby state ST1 to the recording state ST2 in response to the operation on any one of the performance operating elements. Thus, when the user starts the performance, the recording is automatically started. Therefore, the user can record the performance without being forced to carry any operational burden.

When the processor 10 transitions to the recording state ST2, the processor 10 starts recording processing. The recording processing is processing in which each time the user operates any one of the performance operating elements, the performance data D corresponding to the operation is stored in the first storage unit 11A. This recording processing is executed, for example, at a period of 1 ms (an example of a first period). “The user operates any one of the performance operating elements” means that the user operates any one of the 52 white keys 13W, any one of the 36 black keys 13B, or any one of the three pedals. “ms” represents a millisecond.

As described above, when the processor 10 is in the recording state ST2, the processor 10 executes, in the first period (period of 1 ms), processing of storing the performance data D in the first storage unit 11A in response to the operation of the user on the performance operating element.

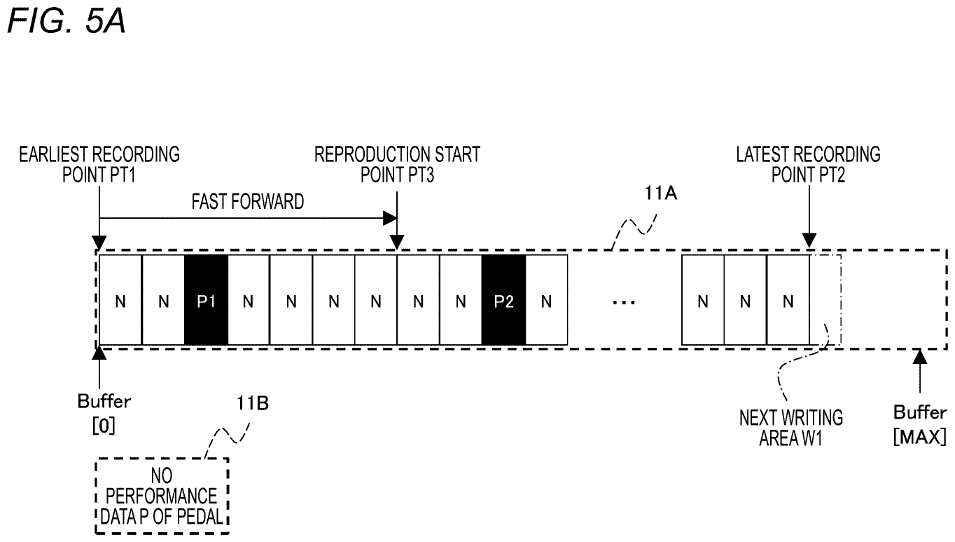

FIGS. 5A and 5B are explanatory diagrams relating to the writing of the performance data D to the first storage unit 11A. Hereinafter, when the performance data D of a note and the performance data D of the pedal are distinguished from each other, the performance data D of the note is referred to as “performance data N” and the performance data D of the pedal is referred to as “performance data P” for convenience.

An earliest recording point PT1 indicates a storage position of earliest performance data D among the performance data D currently stored in the first storage unit 11A.

The latest recording point PT2 indicates a position in which performance data D corresponding to a performance operation to be performed next is stored.

A reproduction start point PT3 indicates a position in which an output of the performance data D is started in the first storage unit 11A during the reproduction processing. The reproduction start point PT3 is an example of a first position corresponding to a point in time that is earlier than a predetermined reference point in time (point in time at which the performance data D corresponding to the next operation on the performance operating element is stored and point in time indicated by the latest recording point PT2) by a first time (time designated by a fast rewind operation of the user).

In order to fast-rewind the performance data D, due to a structure of a format of the performance data D, it is necessary to internally fast-forward from the earliest recording point PT1 to the reproduction start point PT3. That is, the processor 10 reads the first storage unit 11A from the earliest recording point PT1 to the reproduction start point PT3 in a fast forward manner, and starts the reproduction of the performance data D (in other words, output of the performance data D to the sound source LSI 17) from the reproduction start point PT3.

The example in FIG. 5A illustrates a state in which the performance data D is written from the front end (Buffer [0]) of the first storage unit 11A to a middle thereof. In the example of FIG. 5A, the performance data D is not written to the terminal end (buffer [MAX]) of the first storage unit 11A. Therefore, at this stage, the performance data D is not overwritten and erased in the first storage unit 11A. In the example of FIG. 5A, the performance data D is not stored in the second storage unit 11B. For convenience, the writing area of the performance data D corresponding to the performance operation to be performed next is referred to as a “writing area W1”.

In the example of FIG. 5A, the processor 10 reads the first storage unit 11A from the earliest recording point PT1 to the reproduction start point PT3 in a fast forward manner, and updates a set value related to the pedal operation in accordance with the performance data P1 read during the fast forwarding (for example, describes the set value related to the pedal operation based on the performance data P1 in a header chunk of a standard MIDI file (SMF) and outputs the set value to the sound source LSI 17). Accordingly, at the time of starting the reproduction from the reproduction start point PT3, an acoustic effect corresponding to performance data P1 is added to the musical sound to perform the sound generation processing.

That is, when the second performance data (for example, the performance data P) is stored in the first storage unit 11A, the processor 10 instructs the sound source LSI 17 to generate the musical sound based on the performance data P in the reproduction state so as to perform the sound generation processing.

The example of FIG. 5B illustrates a state in which the recording processing is continuously executed from the state in FIG. 5A. In FIG. 5B, performance data D newly written from the state in FIG. 5A is referred to as “performance data D′”. In the example of FIG. 5B, the performance data D is written to the terminal end (buffer [MAX]) of the first storage unit 11A, a recording point returns to the front end (Buffer [0]), and the new performance data D′ is written in order from the front end (Buffer [0]). The performance data P1 of the pedal in the first storage unit 11A is overwritten with the new performance data D′ and is erased.

When the processor 10 reads the first storage unit 11A from the earliest recording point PT1 to the reproduction start point PT3 in a fast forward manner at the time of the reproduction processing, the processor 10 cannot acquire the set value corresponding to the performance data P1 since the performance data P1 of the pedal is overwritten and erased. In this case, when the reproduction starts from the reproduction start point PT3, the sound generation processing is performed without adding the acoustic effect corresponding to the performance data P1 to the musical sound.

Therefore, when the performance data P of the pedal is already stored in an area in which the new performance data D′ is to be written in the first storage unit 11A, the processor 10 stores the performance data P in the area in the second storage unit 11B different from the first storage unit 11A, and overwrites the performance data P in the area with the new performance data D′. That is, when the performance data P (an example of the second performance data) stored in the first storage unit 11A (an example of the first storage area) is overwritten in the recording state, the processor 10 stores the overwritten performance data P in the second storage unit 11B (an example of the second storage area).

In addition, each time the performance data P in the first storage unit 11A is overwritten with the new performance data D′, the processor 10 updates the performance data P stored in the second storage unit 11B to the performance data P erased from the first storage unit 11A by the overwriting.

The processor 10 checks the presence or absence of the performance data P in the second storage unit 11B as pre-processing of the fast forward processing. When the performance data P is stored in the second storage unit 11B, the processor 10 updates the set value related to the pedal performance in accordance with the performance data P, and then reads the first storage unit 11A from the earliest recording point PT1 to the reproduction start point PT3 in a fast forward manner. Accordingly, even when the performance data P is overwritten and erased, the processor 10 can add an acoustic effect corresponding to the performance data P to the musical sound (that is, add an appropriate acoustic effect for faithfully reproducing the recorded performance of the user to the musical sound) when the reproduction starts from the reproduction start point PT3, and perform the sound generation processing.

As described above, when the performance data D is reproduced, the processor 10 reflects the performance data P of the pedal stored in the second storage unit 11B in earliest performance data N among the performance data N stored in the first storage unit 11A and outputs the earliest performance data N.

That is, in the reproduction state, the processor 10 instructs the sound source LSI 17 to generate the musical sound based on the performance data D (an example of the first performance data) stored in the first storage unit 11A (an example of the first storage area) and the performance data P (an example of the second performance data) stored in the second storage unit 11B (an example of the second storage area) so as to perform the sound generation processing.

In addition, in the case in which the processor 10 reads the first storage unit 11A from the earliest recording point PT1 to the reproduction start point PT3 in the fast forward manner, when the second performance data (for example, the performance data P and setting change information to be described later) is stored in the second storage unit 11B, the processor 10 adds the acoustic effect based on the performance data P to the performance data D in the first storage unit 11A or changes setting information such as a tone based on the setting change information, and instructs the sound source LSI 17 to start the sound generation from the reproduction start point PT3 so as to perform the sound generation processing.

In the recording state ST2, when the user short-presses or long-presses the recording button B1, the processor 10 stops the recording (storing the performance data D corresponding to the performance operation) and returns to the standby state ST1.

In the standby state ST1 (or the recording state ST2), when the user short-presses the reproduction/stop button B2 or performs the key pressing operation on any key while pressing the reproduction/stop button B2, the processor 10 transitions to the reproduction state ST3.

When the user short-presses the reproduction/stop button B2, the processor 10 determines the reproduction start point PT3 in the first storage unit 11A, and starts to reproduce the performance data D from the determined reproduction start point PT3. For example, the processor 10 determines, as the reproduction start point PT3, a point in time which is earlier than the latest recording point PT2 by a fixed time (for example, 10 seconds), and starts to reproduce the performance data D.

When the user performs the key pressing operation on any one of the keys while pressing the reproduction/stop button B2, the processor 10 starts to reproduce the performance data D from the reproduction start point PT3 corresponding to the key pressing operation.

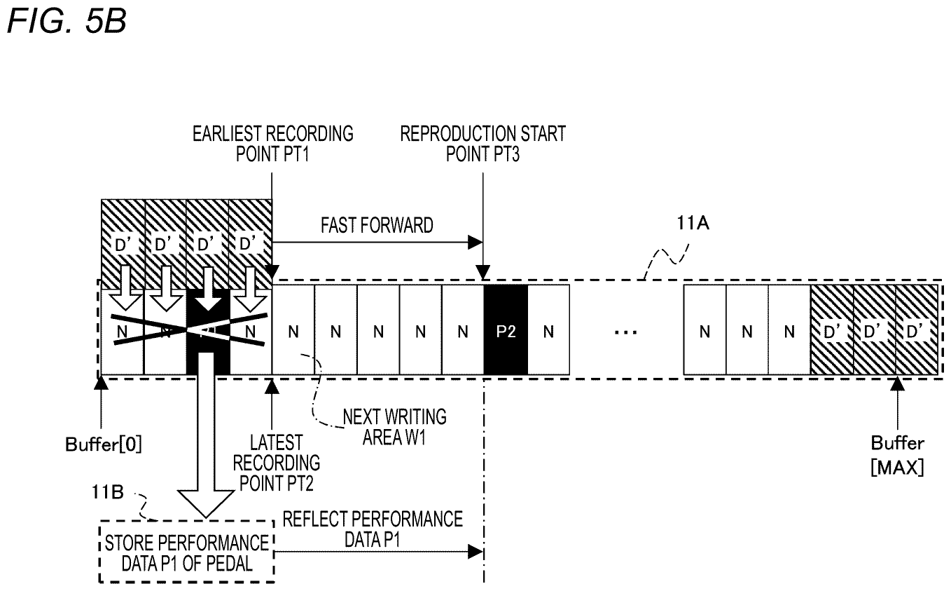

FIG. 6 is an explanatory diagram relating to the reproduction start point PT3 when the user presses the white key 13W while pressing the reproduction/stop button B2. FIG. 6 schematically shows a relationship between the white key 13W pressed by the user and a fast rewind time.

There are 52 white keys 13W, which respectively correspond to ranges of A0 to C8. As illustrated in FIG. 6, the processor 10 determines the fast rewind time at the time of reproduction in response to the white key 13W on which the key pressing operation is performed. For example, as the white key 13W corresponding to the high range is pressed (in other words, as the white key 13W located on a right side in FIG. 6 is pressed), the processor 10 increases the fast rewind time.

The fast rewind time is calculated using the following Formula (1).

$$Fast rewind time ( s ) = n \times 5 ( s ) + 10 ( s ) \qquad Formula ( 1 )$$

Here, (s) represents seconds as a unit.

The processor 10 stores a value n (an example of a first value) in association with each of the white keys 13W in the range A0 to C8. The value n is any one of 1 to 52. The lower the white key 13W is in the range, the smaller the value of n associated with the white key 13W is.

The smallest value n, “1”, is associated to the white key 13W in the range A0, which is the lowest of the ranges A0 to C8. The value n increases by one each time the range of the white key 13W increases by one. Therefore, the largest value n, “52,” is associated to the white key 13W in the range C8, which is the highest of the ranges A0 to C8.

The processor 10 obtains the value n associated with the white key 13W pressed by the user, and substitutes the obtained value n into the above Formula (1) to calculate the fast rewind time (an example of the first time).

For example, when the user presses the white key 13W in the range A0 while pressing the reproduction/stop button B2, the processor 10 calculates 15 seconds as the fast rewind time. For example, when the user presses the white key 13W in the range C2 while pressing the reproduction/stop button B2, the processor 10 calculates 60 seconds as the fast rewind time. For example, when the user presses the white key 13W in the range C8 while pressing the reproduction/stop button B2, the processor 10 calculates 270 seconds as the fast rewind time.

In this way, the user can specify a short fast rewind time by pressing the white key 13W in the low range. The user can specify a long fast rewind time by pressing the white key 13W in the high range. Since the user can grasp a length of the fast rewind time by using the range or a position of the pressed white key 13W as a clue, the user can perform an intuitive fast rewind operation.

The processor 10 determines, as the reproduction start point PT3, a position (an example of the first position) corresponding to a point in time that is earlier than the latest recording point PT2 (an example of the predetermined reference point in time) by the fast rewind time (an example of the first time) calculated using the above Formula (1).

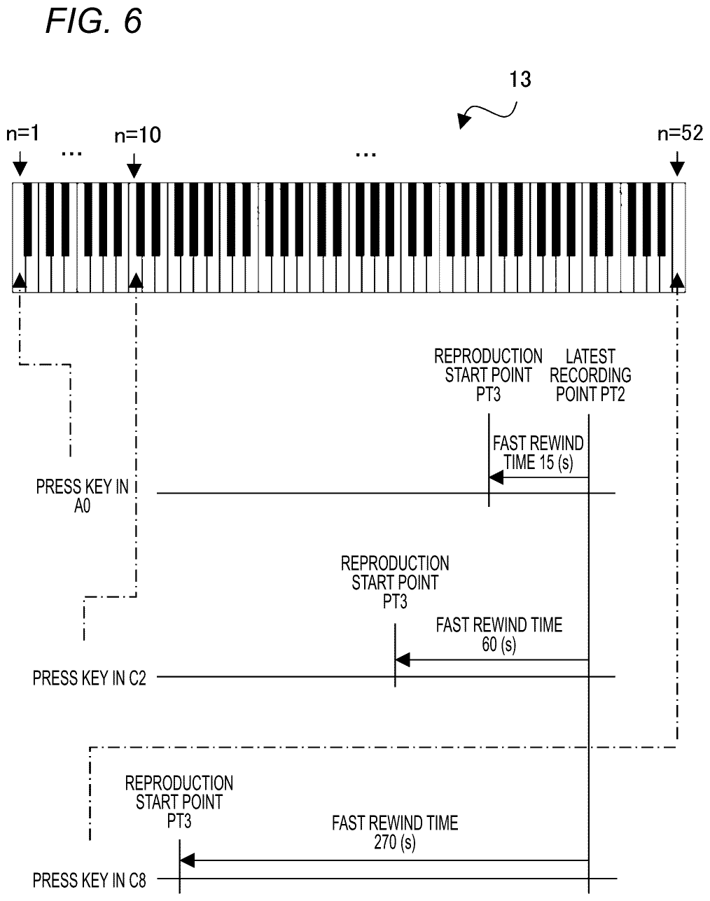

FIG. 7 is a diagram illustrating an example of fast rewind processing executed when the user presses the white key 13W while pressing the reproduction/stop button B2. In FIG. 7, “cumulative Da” is a cumulative time of the difference time Da, and indicates a time obtained by adding the difference time Da of each piece of performance data D in order from the earliest recording point PT1. For example, cumulative Da from the earliest recording point PT1 to the next performance data D is 739 ms obtained by adding 426 ms to 313 ms.

In the example of FIG. 7, the cumulative Da up to the latest recording point PT2 is 123,656 ms. When the user presses the white key 13W in the range C2 while pressing the reproduction/stop button B2, 60,000 ms (=60 seconds) is calculated as the fast rewind time.

In the fast rewind processing, the processor 10 adds the difference times Da of the performance data D from the earliest recording point PT1 to the latest recording point PT2 to calculate the cumulative Da. The processor 10 determines, as the reproduction start point PT3, 63,656 ms corresponding to a point in time that is earlier than the calculated cumulative Da (123,656 ms) by 60,000 ms. As a more specific example, the processor 10 determines, as the reproduction start point PT3, a position of the performance data D in which the cumulative Da is closest to 63,656 ms.

For example, in a general SMF format, a time difference between the pieces of performance data D is managed using a delta time, which is information in a tick unit. At the time of the fast rewind processing, it is necessary to search for a position of the reproduction start point PT3 after the fast rewinding after converting the fast rewind time specified by the user into the information in the tick unit. On the other hand, in the present embodiment, the time difference of the pieces of performance data D is managed using the difference time Da indicating the time. Since conversion processing into the information in the tick unit is unnecessary, a processing load of the processor 10 is reduced.

In this manner, the processor 10 specifies the first position (position corresponding to the point in time that is earlier by the calculated fast rewind time) in the first storage unit 11A (an example of the storage unit) using the difference time Da in each of the plurality of pieces of performance data D, and determines the specified first position as the reproduction start point PT3.

During the reproduction processing, the processor 10 reads the first storage unit 11A from the earliest recording point PT1 in which the cumulative Da is 0 ms to the reproduction start point PT3 (position of the performance data D in which the cumulative Da is closest to 63,656 ms) in the fast forward manner, and starts to reproduce the performance data D from the reproduction start point PT3.

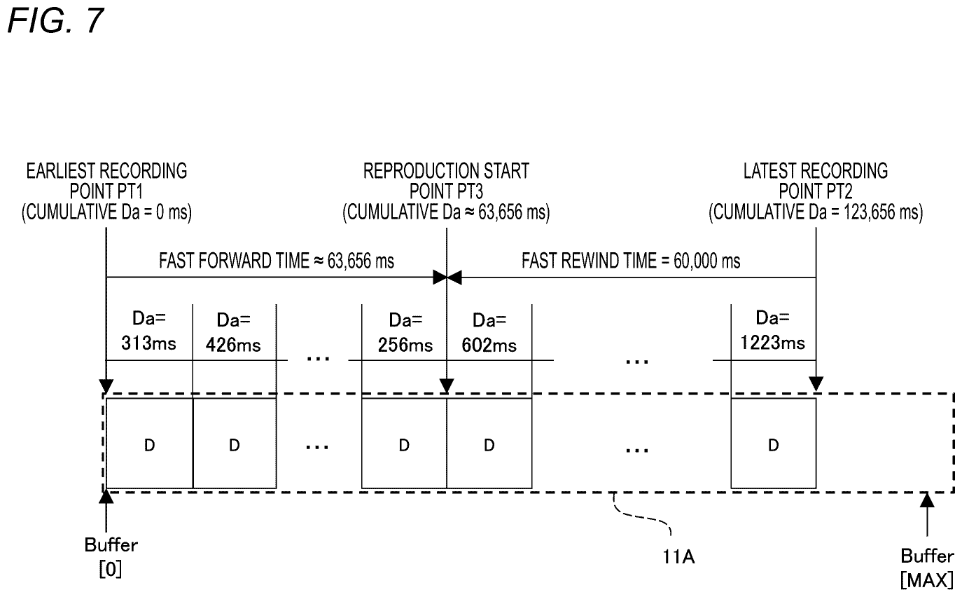

FIG. 8 is an explanatory diagram relating to the reproduction start point PT3 when the user presses the black key 13B while pressing the reproduction/stop button B2. FIG. 8 schematically shows a relationship between the black key 13B pressed by the user and the fast rewind time.

There are 36 black keys 13B, which respectively correspond to ranges of A #0 to A #7. As illustrated in FIG. 8, the processor 10 determines a fast rewind time at the time of reproduction in response to the black key 13B pressed by the user.

The processor 10 stores marks M1 to M36 (an example of an identifier) in association with the 36 black keys 13B (black keys 13B in the ranges A #0 to A #7), respectively.

For example, in the recording state ST2, each time the user short-presses the button B1 (each time the user performs a mark operation), the processor 10 registers a mark M at a recording start position in the first storage unit 11A indicated by the latest recording point PT2 at that point in time (in other words, the processor 10 associates the mark M with the above-mentioned recording start position).

More specifically, when the user performs the mark operation, the processor 10 normally registers a mark M1 associated with the black key 13B (A #0) located at the leftmost position in the keyboard 13 with respect to the recording start position in the first storage unit 11A indicated by the latest recording point PT2 at that point in time.

Each time the mark M1 is registered for a new recording start position, the black key 13B corresponding to each recording start position before this time is moved to the next black key 13B on the right. In other words, a mark M having a sign number larger by one is registered for each recording start position before this time.

For example, when the mark M1 is registered for a new recording start position, marks M2, M3, and M4 are registered at the recording start positions in which the marks M1, M2 and M3 has been registered up until then, respectively. That is, the mark M whose number is incremented by 1 is registered at each recording start position before this time. Therefore, for example, the black key 13B (F #1) corresponding to the mark M4 indicates a reproduction start position in the first storage unit 11A marked for the penultimate fourth time.

When the processor 10 transitions to the recording state ST2, the processor 10 may register the mark M1 with respect to the recording start position in the first storage unit 11A indicated by the latest recording point PT2 at that point in time regardless of whether there is a mark operation performed by the user.

Registration information of the mark M is erased when the power supply of the electronic musical instrument 1 is turned off.

For example, when the recording processing is executed 13 times after the power supply of the electronic musical instrument 1 is turned on, the marks M1 to 13 are registered with respect to recording start positions at respective points in time (see FIG. 8). The marks M1 to M13 are stored in association with the black keys 13B in the ranges A #0 to D #3, respectively.

Therefore, for example, when the user presses the black key 13B in the range C #3 while pressing the reproduction/stop button B2, the processor 10 acquires the mark M12 associated with the black key 13B, and determines, as the reproduction start point PT3, a position in the first storage unit 11A in which the mark M12 is registered as shown in FIG. 8.

For example, when the user presses the black key 13B in the range F #1 while pressing the reproduction/stop button B2, the processor 10 acquires the mark M4 associated with the black key 13B, and determines, as the reproduction start point PT3, a position in the first storage unit 11A in which the mark M4 is registered as shown in FIG. 8.

As described above, the lower the range of the black key 13B pressed by the user is, the more recently recorded performance can be reproduced, and the higher the range of the black key 13B pressed by the user is, the more previously recorded performance can be reproduced. The user can intuitively grasp a point in time to which the fast rewinding is performed by using the range and a position of the pressed black key 13B as a clue.

For example, when the user wants to listen to a performance thereof a little earlier (for example, from an adjacent position marked earlier) than a point in time of the reproduction after the performance data of the performance of the user is reproduced by pressing a certain black key 13B, the user may simply press the next black key 13B on the right of the certain black key 13B. Further, when the user wants to listen to the performance thereof a little later (for example, from a next position marked later) than the point in time of the reproduction, the user may simply press the adjacent black key 13B on the left of the certain black key 13B.

Whether in the standby state ST1 or the recording state ST2, the user can determine the fast rewind time (in other words, quickly designate the reproduction start point PT3 as the reproduction start position) by a one-action operation of pressing the white key 13W or the black key 13B in a state in which the reproduction/stop button B2 is pressed.

The reproduction processing is executed, for example, at a period of 5 ms (an example of a second period) until the reproduction of the performance data D, which started from the reproduction start point PT3, is stopped or terminated.

That is, during the reproduction processing, the processor 10 executes processing of outputting the performance data D stored in the first storage unit 11A at a period of 5 ms (an example of the second period) longer than a period of 1 ms (an example of the first period). More specifically, in the reproduction processing, the processor 10 outputs the performance data D stored in the first storage unit 11A to the sound source LSI 17 at a period of 5 ms longer than a period of 1 ms which is a period of the recording processing. The sound source LSI 17 performs the sound generation processing based on the performance data D input from the processor 10.

The processor 10 executes the recording processing at a period of 1 ms, thereby obtaining the performance data D at a high sampling rate. Here, in order to reproduce the recorded performance with high reproducibility, it is conceivable to execute the reproduction processing in the same period of 1 ms as the recording processing. However, when the reproduction processing is executed at a high speed, a processing load of the electronic musical instrument 1 increases. Due to an influence of this increase in processing load, a reproduced sound may not be appropriately reproduced (for example, the reproduced sound slows down). “The reproduced sound slows down” means, for example, that the reproduced sound tends to be delayed or temporarily out of sync.

Therefore, in the present embodiment, an execution period of the reproduction processing is made shorter than an execution period of the recording processing. Accordingly, the processing load of the electronic musical instrument 1 is reduced, and it is possible to prevent a failure in which a reproduced sound is not appropriately reproduced.

When the reproduction processing is performed at a period of 5 ms, at a tempo of 255 bpm, reproducibility of up to 128 notes (approximately 7.3 ms per note) is possible, for example. That is, even when the execution period of the reproduction processing is made shorter than the execution period of the sound recording processing, sufficient reproducibility with no sense of incongruity can be obtained in a hearing sense.

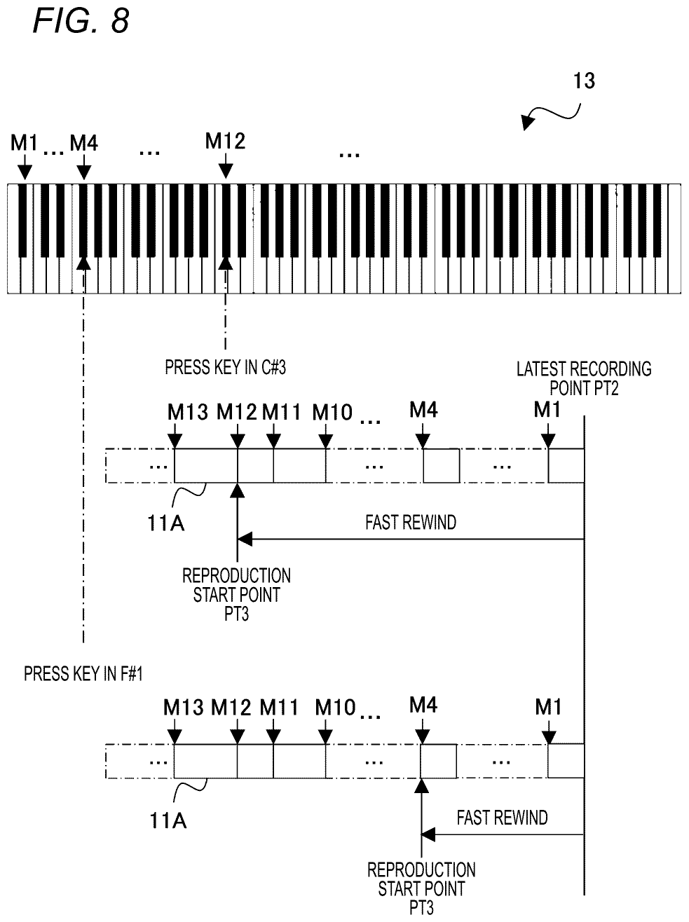

FIG. 9 is a diagram illustrating an example of a processing timing when the electronic musical instrument 1 reproduces the performance data D. In the example of FIG. 9, the reproduction start point PT3 is placed at a position indicating performance data D1. In the first storage unit 11A, performance data D1, D2, D3, D4, D5, and D6 are sequentially located from the reproduction start point PT3.

The processor 10 acquires the difference time Da in each piece of performance data D (after the performance data D2) located after the reproduction start point PT3. For example, the processor 10 acquires 3 ms, 8 ms, 1 ms, 5 ms, and 2 ms as the difference times Da in the performance data D2 to D6, respectively.

The processor 10 outputs the corresponding performance data D to the sound source LSI 17 each time the execution period (period of 5 ms) of the reproduction processing arrives based on the acquired difference time Da.

Specifically, the processor 10 detects the performance data D to be output in a first execution period (reproduction elapsed time: 0 ms to 5 ms) based on the difference time Da, and outputs the detected performance data D to the sound source LSI 17. The processor 10 also detects and outputs the corresponding performance data D in the subsequent execution periods (reproduction elapsed time: 5 ms to 10 ms, 10 ms to 15 ms, . . . ) based on the difference time Da.

The difference times Da of the performance data D2 to D6 are 3 ms, 8 ms, 1 ms, 5 ms, and 2 ms, respectively. This means that an output timing of the performance data D2 arrives after 3 ms from the output of the performance data D1, an output timing of the performance data D3 arrives after 8 ms, an output timing of the performance data D4 arrives after 1 ms, an output timing of the performance data D5 arrives after 5 ms, and an output timing of the performance data D6 arrives after 2 ms.

The performance data D1 and D2 are output at 0 seconds and 3 ms, respectively, of the reproduction elapsed time. Therefore, the output timings of the performance data D1 and D2 belong to the first execution period (reproduction elapsed time: 0 ms to 5 ms). The processor 10 detects the performance data D1 and D2 as the performance data D to be output in the first execution period (reproduction elapsed time: 0 ms to 5 ms) and outputs the performance data D1 and D2 to the sound source LSI 17.

The performance data D3 and D4 are output at 11 ms (value obtained by adding 8 ms to 3 ms) and 12 ms (value obtained by adding 1 ms to 11 ms) of the reproduction elapsed time, respectively. Therefore, the output timings of the performance data D3 and D4 do not belong to a second execution period (reproduction elapsed time: 5 ms to 10 ms). The output timings of the performance data D3 and D4 belong to a third execution period (reproduction elapsed time: 10 ms to 15 ms). The processor 10 does not output any performance data D in the second execution period (reproduction elapsed time: 5 ms to 10 ms). The processor 10 detects the performance data D3 and D4 as the performance data D to be output in the third execution period (reproduction elapsed time: 10 ms to 15 ms) and outputs the performance data D3 and D4 to the sound source LSI 17.

The output timings of the performance data D5 and D6 are 17 ms and 19 ms of the reproduction elapsed time, respectively. Therefore, the output timings of the performance data D5 and D6 belongs to a fourth execution period (reproduction elapsed time: 15 ms to 20 ms). The processor 10 detects the performance data D5 and D6 as the performance data D to be output in the fourth execution period (reproduction elapsed time: 15 ms to 20 ms) and outputs the performance data D5 and D6 to the sound source LSI 17.

That is, each time the execution period (period of 5 ms) of the reproduction processing arrives, the processor 10 collectively outputs the performance data D belonging to the period to the sound source LSI 17. In other words, the processor 10 aligns the performance data D in 5 ms units (quantizes the performance data D in 5 ms units, which are an example of the second period), and outputs the performance data D to the sound source LSI 17.

In the present embodiment, the output timing of each piece of performance data D is managed using the difference time Da indicating the time. The processing load of the processor 10 is reduced as compared with the case in which the output timing of the performance data D is managed using the delta time which is the information of the tick unit.

In the reproduction state ST3, when the user performs the key pressing operation on any one of the keys, the processor 10 stops the output of the performance data D, and fast-rewinds by only a time corresponding to the key on which the key pressing operation is performed, starting from a stop position. The processor 10 resumes the output of the performance data D from a position after the fast rewinding.

In the reproduction state ST3, when the user short-presses the reproduction/stop button B2, the electronic musical instrument 1 stops the reproduction processing being executed and returns to the standby state ST1.

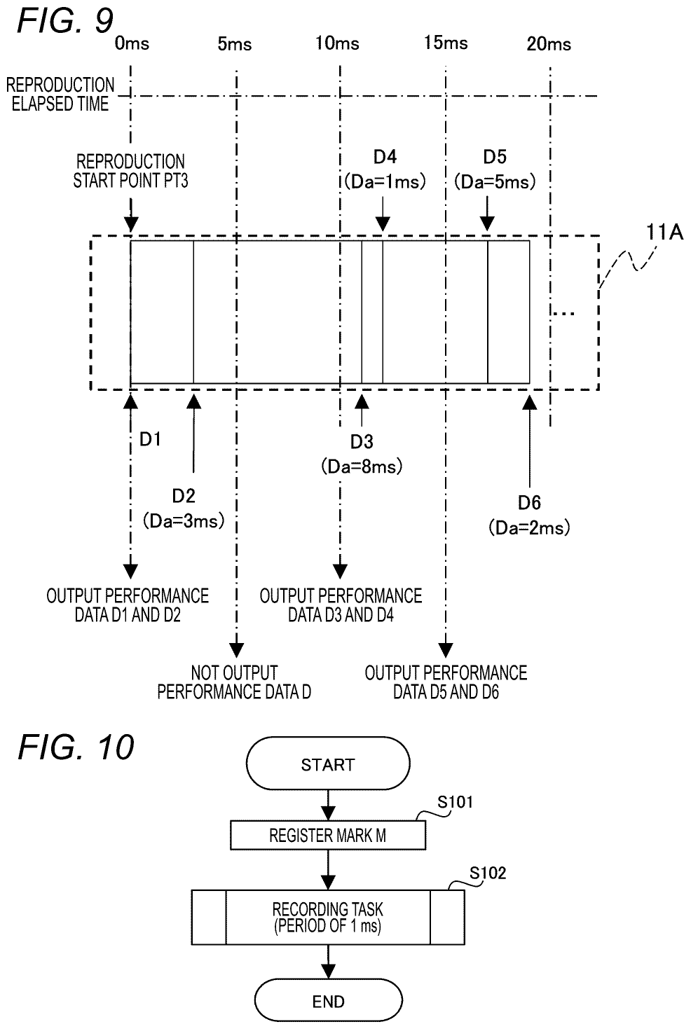

FIG. 10 is a flowchart of the recording processing executed by the processor 10 when the processor 10 transitions from the standby state ST1 to the recording state ST2.

The processor 10 registers the mark M at the recording start position in the first storage unit 11A indicated by the latest recording point PT2 at that point in time (step S101).

For example, in response to the mark operation performed by the user, the processor 10 registers the mark M1 at the recording start position in the first storage unit 11A indicated by the latest recording point PT2 at that point in time. Thereafter, each time the mark operation is performed, the processor 10 registers the mark M1 with respect to the recording start position at that point in time, and increments the number of the mark M previously marked by 1.

As described above, when the storage of the performance data D in the first storage unit 11A (an example of the storage unit) is started, the processor 10 registers the mark M (an example of the identifier) at the recording start position (an example of a storage start position of the performance data in the storage unit) indicated by the latest recording point PT2.

The processor 10 executes a recording task (step S102).

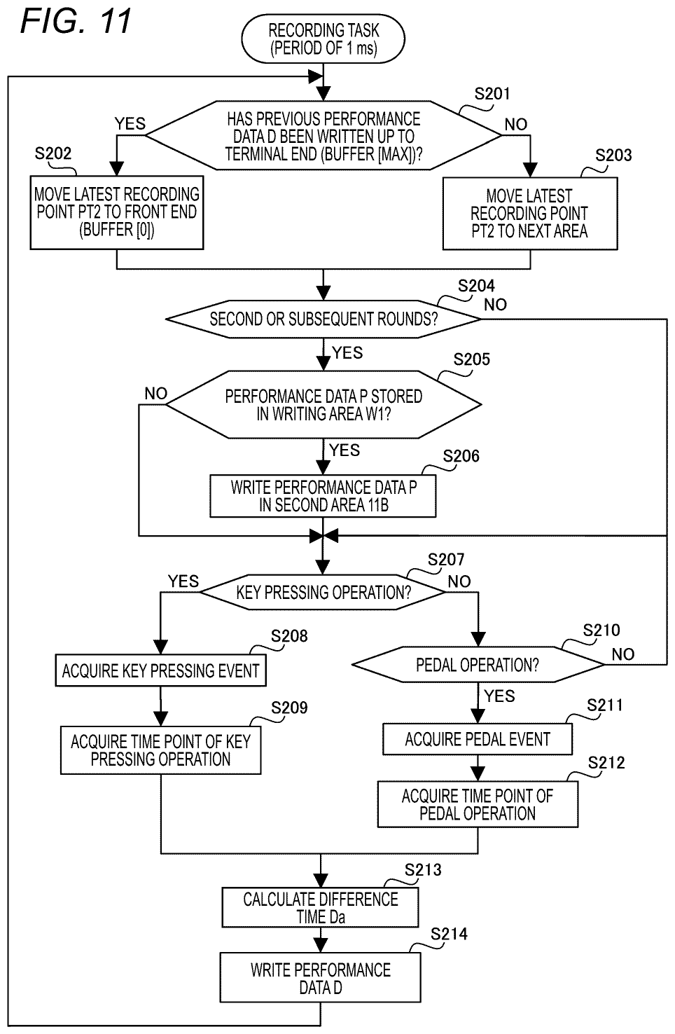

FIG. 11 is a subroutine showing a detail of the recording task (step S102) in FIG. 10. The processor 10 repeatedly executes this recording task at a period of 1 ms until the recording processing is completed (in other words, until the processor 10 transitions from the recording state ST2 to the standby state ST1 or the reproduction state ST3).

When the previous performance data D has been written up to the terminal end (buffer [MAX]) of the first storage unit 11A (step S201: YES), the processor 10 moves the latest recording point PT2 to the front end (Buffer [0]) of the first storage unit 11A (step S202). That is, a head area of the first storage unit 11A is the next writing area W1.

When the previous performance data D has not been written up to the terminal end (buffer [MAX]) of the first storage unit 11A (step S201: NO), the processor 10 moves the latest recording point PT2 to a next area in the first storage unit 11A (step S203). That is, an area immediately following the area in which the previous performance data D has been written becomes the next writing area W1.

The processor 10 determines whether the performance data D is written to the first storage unit 11A for a second or subsequent rounds (step S204). The “second or subsequent rounds” indicates a state in which the performance data D is written to the terminal end (buffer [MAX]) of the first storage unit 11A at least once after the power supply of the electronic musical instrument 1 is turned on and the latest recording point PT2 moves to the front end (Buffer [0]).

When the performance data D is not written to the first storage unit 11A for the second or subsequent round (in other words, for the first round) (step S204: NO), the processor 10 determines whether the key pressing operation has been performed on the keyboard 13 (step S207). When no key pressing operation has been performed (step S207: NO), the processor 10 determines whether the pedal operation has been performed on the pedal unit 14 (step S210).

During the execution of the recording task in FIG. 11, the processor 10 repeatedly executes the determination processing in steps S207 and S210 in a period of 1 ms until the key pressing operation or the pedal operation is performed.

When the key pressing operation is performed (step S207: YES), the processor 10 acquires the key pressing event corresponding to the key pressing operation (step S208). The processor 10 acquires a time point of the key pressing operation from the RTC 10A (step S209). The key pressing event includes, for example, a note number and a velocity.

When the pedal operation is performed (step S210: YES), the processor 10 acquires a pedal event corresponding to the pedal operation (step S211). The processor 10 acquires a time point of the pedal operation from the RTC 10A (step S212). The pedal event includes, for example, a pedal type, a pedal stepping-on value, and the like.

The processor 10 calculates the difference time Da between the time point of the previous performance operation (key pressing operation or pedal operation) and the time point of the current performance operation (key pressing operation or pedal operation) (step S213).

The processor 10 writes information obtained by adding the difference time Da calculated in step S213 to the command type Db (note-on, control change, and the like) and the command data Dc (note number, velocity, and the like) in the event (key pressing event or pedal event) as the performance data D (performance data N of the note or performance data P of the pedal) in the next writing area W1 indicated by the latest recording point PT2 (step S214), and returns to the processing of step S201.

When the performance data D is written to the first storage unit 11A for the second or subsequent round (step S204: YES), the processor 10 determines whether the performance data P of the pedal is stored in the next writing area W1 indicated by the latest recording point PT2 (step S205).

When the performance data P of the pedal is stored in the next writing area W1 (step S205: YES), the processor 10 writes this performance data P into the second storage unit 11B (step S206), and then executes the processing of step S207 and subsequent steps.

Accordingly, even if the processing of step S207 and subsequent steps is executed and the performance data P in the next writing area W1 is overwritten and erased, the processor 10 can add the acoustic effect thereof to the musical sound and perform the sound generation processing by reading the performance data P written in the second storage unit 11B and updating the set value related to the pedal performance when the reproduction is started from the reproduction start point PT3.

Each time the performance data P is overwritten and erased in the first storage unit 11A, the performance data P in the second storage unit 11B is updated to the performance data P that is overwritten and erased.

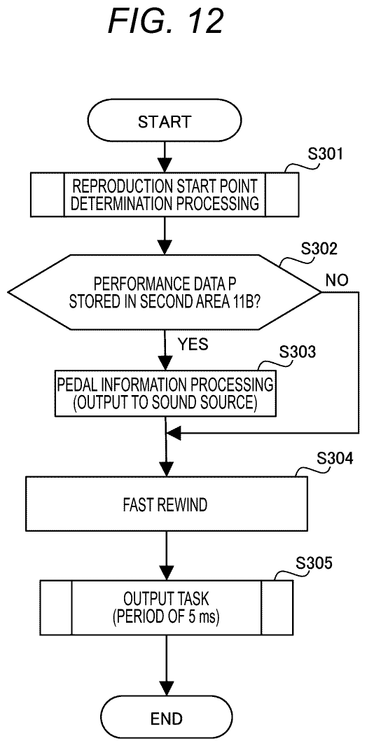

FIG. 12 is a flowchart of the reproduction processing executed by the processor 10 when the processor 10 transitions from the standby state ST1 or the recording state ST2 to the reproduction state ST3.

The processor 10 executes the reproduction start point determination processing (step S301).

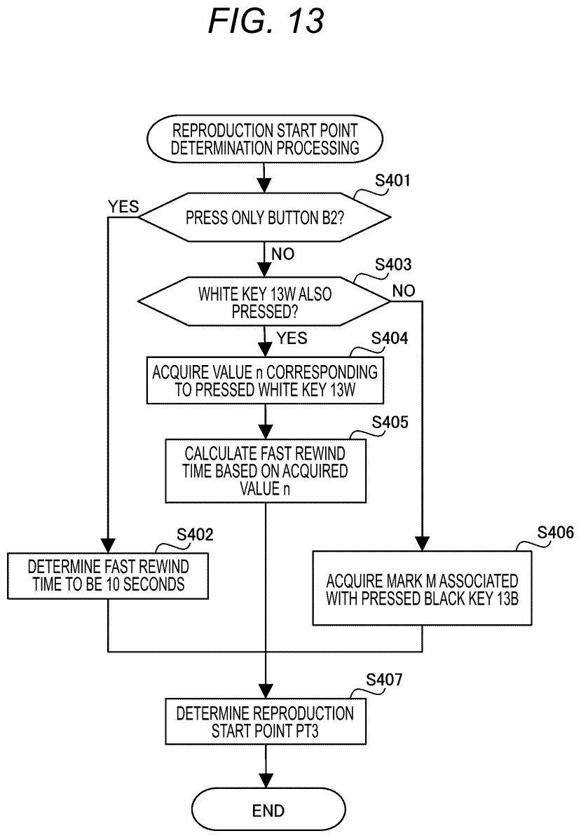

FIG. 13 is a subroutine illustrating a detail of the reproduction start point determination processing (step S301) shown in FIG. 12.

The processor 10 determines the reproduction start point PT3 according to an operation content that triggered the transition from the standby state ST1 or the recording state ST2 to the reproduction state ST3.

Specifically, when only the reproduction/stop button B2 is pressed (step S401: YES), the processor 10 determines the fast rewind time to be 10 seconds (step S402). The processor 10 determines, as the reproduction start point PT3, a point in time which is earlier than the latest recording point PT2 by 10 seconds (step S407).

When the white key 13W is pressed while the reproduction/stop button B2 is pressed (step S401: NO and step S403: YES), the processor 10 acquires the value n associated with the pressed white key 13W (step S404), and substitutes the acquired value n into the above Formula (1) to calculate the fast rewind time (step S405). The processor 10 determines, as the reproduction start point PT3, a point in time earlier than the latest recording point PT2 by the fast rewind time calculated in step S405 (step S407).

When the black key 13B is pressed while the reproduction/stop button B2 is pressed (step S401: NO and step S403: NO), the processor 10 acquires the mark M associated with the pressed black key 13B (step S406), and determines, as the reproduction start point PT3, a position in the first storage unit 11A in which the acquired mark M is registered (step S407).

As described above, when the user operates any one of the plurality of performance operating elements (any one of the white keys 13W or any one of the black keys 13B) in a state (an example of a first operation state) in which the reproduction/stop button B2 (an example of a first operation unit) is pressed by the user, the processor 10 determines the reproduction start point PT3 in the first storage unit 11A according to the operated performance operating element (white key 13W or black key 13B).

The processor 10 determines whether the performance data P of the pedal is stored in the second storage unit 11B (step S302).

When the performance data P is stored in the second storage unit 11B (step S302: YES), the processor 10 performs pedal information processing (step S303). Specifically, the processor 10 reads out the performance data P stored in the second storage unit 11B, describes a set value related to the pedal operation based on the read performance data P in the header chunk, and outputs the set value to the sound source LSI 17. Accordingly, the set value related to the pedal performance is updated, and the acoustic effect according to the updated set value is added to the musical sound and then the sound generation processing is performed.

The processor 10 is fast-rewound to the reproduction start point PT3 determined in step S301 (step S304). Specifically, the processor 10 internally performs the fast forward processing from the earliest recording point PT1 to the reproduction start point PT3 in the first storage unit 11A.

The processor 10 executes an output task (step S305).

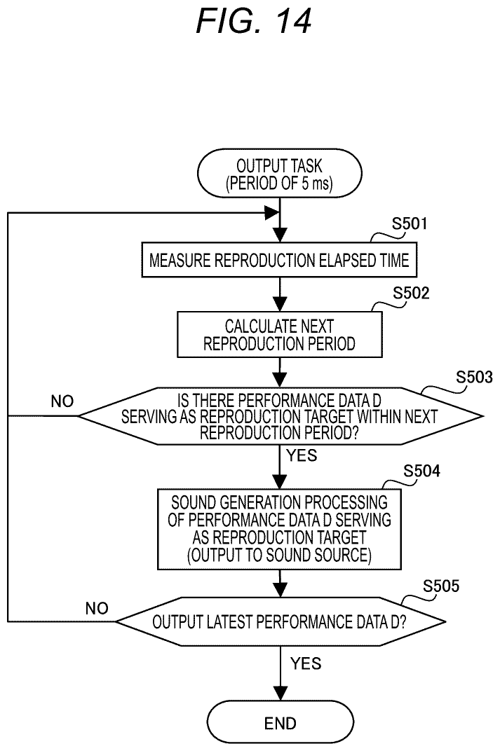

FIG. 14 is a subroutine illustrating a detail of the output task (step S305) in FIG. 12. The processor 10 repeatedly executes this output task at a period of 5 ms until the output of the performance data D is stopped or terminated.

When a transition operation to the standby state ST1 is performed during the execution of the output task (step S305), the output task is terminated simultaneously with the stop of the output of the performance data D. Further, when the user performs the key pressing operation on any one of the keys during the execution of the output task, the output task is terminated simultaneously with the stop of the output of the performance data D. In the latter case, after the output of the performance data D is stopped, the reproduction processing in FIG. 12 is restarted from the beginning (that is, from step S301).

When all of the performance data D from the reproduction start point PT3 to the latest recording point PT2 is output to the sound source LSI 17, the output of the performance data D is terminated and the output task is also terminated.

The processor 10 measures an elapsed time (reproduction elapsed time) from the time point acquired from the RTC 10A after the start of the output task (step S501). Here, the reproduction elapsed time at the time of first execution in step S501 is set to 0 ms. The reproduction elapsed time during the execution of step S501 from the mth time (m is 2 or more) onwards may vary slightly depending on the processing load of the processor 10, but is basically a time obtained by multiplying 5 ms by a value m.

The processor 10 calculates a next reproduction period (step S502).

For example, the processor 10 calculates, as the next reproduction period, a period starting from the reproduction elapsed time measured in step S501 and ending at 5 ms after the start point, which is the period of the output task. As an example, when step S502 is executed for the first time, 0 ms to 5 ms is calculated as the next reproduction period. In the case in which the reproduction elapsed time is 5.1 ms when step S501 is executed for the second time, 5.1 ms to 10.1 ms is calculated as the next reproduction period.

The processor 10 detects the performance data D serving as a reproduction target within the next reproduction period calculated in step S502 (step S503). In the example of FIG. 9, when the next reproduction period is 0 ms to 5 ms, the processor 10 detects the performance data D1 and D2 serving as reproduction targets (step S503: YES). When the performance data D serving as the reproduction target is not detected (step S503: NO), the processor 10 returns to the processing in step S501 and executes processing for the next reproduction period.

The processor 10 performs the sound generation processing of the performance data D serving as the reproduction target detected in step S503 (step S504). That is, the processor 10 outputs the performance data D serving as the reproduction target to the sound source LSI 17.

When the latest performance data D (performance data D at the latest recording point PT2) is not output to the sound source LSI 17 (step S505: NO), the processor 10 returns to the processing in step S501 and executes the processing for the next reproduction period. That is, the processor 10 repeats the processing of steps S501 to S505 until the performance data D of the latest recording point PT2 is output to the sound source LSI 17.

When the performance data D of the latest recording point PT2 is output to the sound source LSI 17 (step S505: YES), the processor 10 ends the output task. Accordingly, the reproduction processing ends, and the processor 10 transitions to the standby state ST1.

As described above, the processor 10 starts the output of the performance data D from the reproduction start point PT3 determined in the reproduction start point determination processing (step S301), and repeatedly executes the output task (step S305) at the period of 5 ms until the output of the performance data D is stopped or ended.

In addition, the present invention is not limited to the above-described embodiment, and various modifications can be made without departing from the gist of the present invention in the implementation stage. Further, the functions executed in the above-described embodiments may be appropriately combined wherever appropriate. The above-described embodiment includes various stages, and various inventions can be extracted by appropriately combining a plurality of the disclosed components. For example, even if some components are deleted from all the components disclosed in the embodiments, a configuration in which the components are deleted can be extracted as an invention as long as the effect can be obtained.

In the above embodiment, the processor 10 writes the performance data P of the pedal overwritten and erased in the first storage unit 11A to the second storage unit 11B during the recording processing. In the reproduction processing, the processor 10 reads out the performance data P stored in the second storage unit 11B, describes the set value related to the pedal operation based on the read performance data P in the header chunk, and outputs the set value to the sound source LSI 17.

In another embodiment, at the time of the recording processing, the processor 10 may write not only the performance data P of the pedal but also the setting change information of the tone and the various effects in the second storage unit 11B, similarly to the performance data P of the pedal. The setting change information includes, for example, tone information set according to a tone switching operation performed on the switch panel 15 by the user, and effect switching information set according to an effect switching operation performed on the switch panel 15 by the user. The switch panel 15 is a setting change operating element which is an example of the second operating element, and receives an operation of changing the setting information including the tone and the various effects.

In another embodiment, at the time of the reproduction processing, the processor 10 reads the setting change information of the tone and the various effects stored in the second storage unit 11B, describes the read setting change information in the header chunk, and outputs the setting change information to the sound source LSI 17. Accordingly, for example, even when the setting change information of the tone and the various effects is overwritten and erased in the first storage unit 11A, the musical sound can be generated with the tone and the effects corresponding to the setting change information.

What is claimed is:

1. An electronic musical instrument comprising:
a performance operating element;
a storage unit configured to store performance data corresponding to an operation each time a user operates the performance operating element; and
at least one processor, wherein
the at least one processor executes:
in a first period, processing of storing the performance data in the storage unit in response to the operation of the user on the performance operating element in a case of being in a recording state; and
in a second period longer than the first period, processing of outputting the performance data stored in the storage unit in a case of being in a reproduction state.

2. The electronic musical instrument according to claim 1, wherein
in the processing of outputting the performance data, the at least one processor quantizes the performance data in the second period.

3. The electronic musical instrument according to claim 1, wherein
the at least one processor
acquires a system time in response to the operation, and
acquires difference time information between a time of a previous operation and a time of a current operation based on the acquired system time, and
the performance data includes the difference time information.

4. The electronic musical instrument according to claim 1, wherein
a difference time between a previous time point at which the performance operating element is operated and a current time point at which the performance operating element is operated is in current performance data and stored, and
the at least one processor acquires the difference time in each performance data located after a reproduction start position in the storage unit, and
the at least one processor outputs the corresponding performance data each time the second period arrives, based on the acquired difference time.

5. The electronic musical instrument according to claim 1, wherein
the at least one processor transitions to the recording state in response to the user operating the performance operating element in a case in which the processor is in a standby state instead of being in the recording state and the reproduction state.

6. The electronic musical instrument according to claim 1, wherein
the performance operating element is a keyboard, and
the processing of outputting the performance data is executed based on a user operation on the keyboard.

7. A method comprising: by a computer,
executing, in a first period, processing of storing performance data in a storage unit in response to an operation of a user on a performance operating element in a case of being in a recording state; and
executing, in a second period longer than the first period, processing of outputting the performance data stored in the storage unit in a case of being in a reproduction state.

8. The method according to claim 7, wherein
in the processing of outputting the performance data, the performance data is quantized in the second period.

9. The method according to claim 7, further comprising:
acquiring a system time in response to the operation; and
acquiring difference time information between a time of a previous operation and a time of a current operation based on the acquired system time, wherein
the performance data includes the difference time information.

10. The method according to claim 7, wherein
a difference time between a previous time point at which the performance operating element is operated and a current time point at which the performance operating element is operated is included in current performance data and stored,
the difference time in each performance data located after a reproduction start position in the storage unit is acquired, and
based on the acquired difference time, the corresponding performance data is output each time the second period arrives.

11. The method according to claim 7, further comprising:
transitioning to the recording state in response to the user operating the performance operating element in a case of being in a standby state instead of being in the recording state and the reproduction state.

12. A non-transitory recording medium that stores a program for causing a computer to:
execute, in a first period, processing of storing performance data in a storage unit in response to an operation of a user on a performance operating element in a case of being in a recording state; and
execute, in a second period longer than the first period, processing of outputting the performance data stored in the storage unit in a case of being in a reproduction state.

13. The non-transitory recording medium that stores a program according to claim 12, wherein
in the processing of outputting the performance data, the performance data is quantized in the second period.

14. The non-transitory recording medium that stores a program according to claim 12, wherein
a system time is acquired in response to the operation,
difference time information between a time of a previous operation and a time of a current operation is acquired based on the acquired system time, and
the performance data includes the difference time information.

15. The non-transitory recording medium that stores a program according to claim 12, wherein
a difference time between a previous time point at which the performance operating element is operated and a current time point at which the performance operating element is operated is included in current performance data and stored,
the difference time in each performance data located after a reproduction start position in the storage unit is acquired, and
based on the acquired difference time, the corresponding performance data is output each time the second period arrives.

16. The non-transitory recording medium that stores a program according to claim 12, wherein
the computer transitions to the recording state in response to the user operating the performance operating element in a case in which the computer is in a standby state instead of being in the recording state and the reproduction state.
